(19) United States
(12) Patent Application Publication
(10) Pub. No.: US 2003/0200605 A1
(43) Pub. Date: Oct. 30, 2003

(54) Water jet with strainer

(75) Inventors: Casey Loyd, Pomona (CA); Alberto Olivo, Pomona (CA)

Correspondence Address: Denton L. Anderson, SHELDON & MAK, 9th Floor, 225 South Lake Avenue, Pasadena, CA, 91101, US

(73) Assignee: California Acrylic Industries

(21) Appl. No.: 10/135,169

(22) Filed: Apr. 30, 2002

(51) Int. Cl. A61H 33/04

(52) U.S. Cl. 4/541.6

(57) ABSTRACT

A water jet having a housing, a flow tube and a strainer. The housing has an open forward end. The flow tube is disposed within the housing for conducting a stream of water through the open forward end of the housing. The strainer is operably disposed within the flow tube to filter out entrained solid material within a stream of water flowing through the flow tube. The water jet is ideal for use in a water recreational combination such as a spa, hot tub or recirculating bath tub.

### FIELD OF THE INVENTION

This invention relates generally to spas, hot tubs, recirculating bath tubs and the like and, more specifically, to water jets used in such equipment.

### BACKGROUND OF THE INVENTION

Spas, hot tubs, recirculating bath tubs and the like are becoming ever increasingly popular as recreational devices and as therapeutic devices.

The key feature of all such devices is a plurality of water jets disposed in the side walls of the water basin of such equipment. Such water jets provide the user with a pleasant and relaxing sensation. The water jets also frequently provide the user with therapeutic benefits, as well.

One of the most popular water jets is a rotating water jet. In a typical rotating water jet, water flowing through the jet rotates a rotatable discharge nozzle disposed at the outlet of the jet. The rotatable discharge nozzle rotates about a central axis with the aid of ball bearings or other rotatable bearings.

A problem exists in the operation of such rotatable jets. This problem stems from the periodic entrainment of sand, grit and/or other sediment in the water stream flowing through the jet. Such sand, grit or other sediment can clog the bearings which journal the rotatable nozzles and will frequently lead to the premature failure of the bearings.

Accordingly, there is a need for an improved water jet which avoids this problem in the prior art.

### SUMMARY OF THE INVENTION

The invention satisfies this need. The invention is a water jet suitable for use in a spa (a) a housing having an open forward end, (b) a flow tube disposed within the housing for conducting a stream of water from a source of pressurized water disposed external of the housing to the open forward end of the housing, and (c) a strainer operatively disposed within the flow tube to filter out entrained solid material within a stream of water flowing through the flow tube.

### DESCRIPTION OF THE DRAWINGS

These and other features, aspects and advantages of the present invention will become better understood with reference to the following description, appended claims and accompanying drawings where:

FIG. 1 is a side view of a spa jet having features of the invention;

FIG. 2 is an isometric detail view of a spa strainer useable in the spa jet illustrated in FIG. 1; and

FIG. 3 is a second isometric detail view of the spa strainer illustrated in FIG. 2.

### DETAILED DESCRIPTION

The following discussion describes in detail one embodiment of the invention and several variations of that embodiment. This discussion should not be construed, however, as limiting the invention to those particular embodiments. Practitioners skilled in the art will recognize numerous other embodiments as well.

The invention is a water jet 10 suitable for use in a water recreational combination 12 such as a spa, hot tub or recirculation bath tub. The water jet 10 comprises a housing 14, a flow tube 16 and a strainer 18.

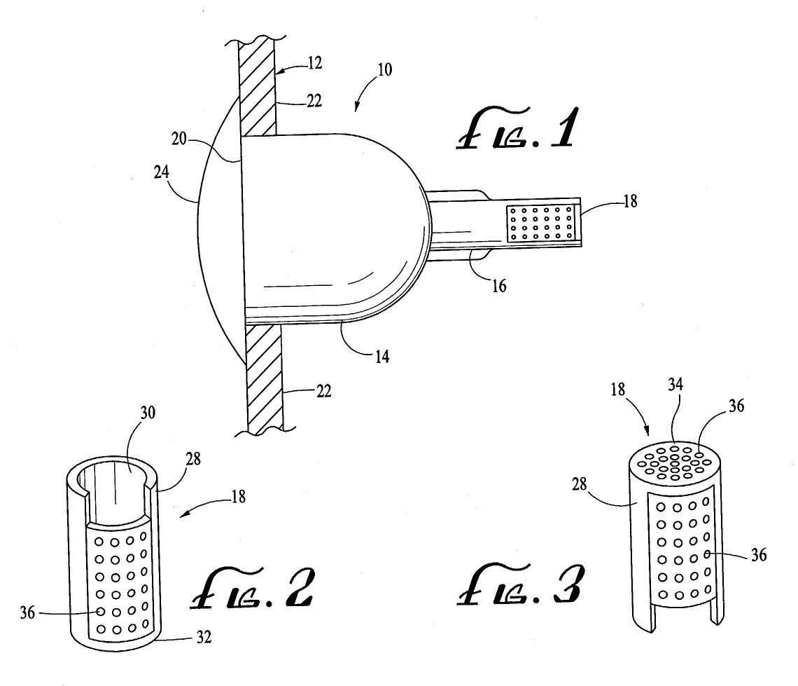

The spa jet of the invention 10 is illustrated in FIG. 1. The water jet housing 14 has an opening forward end 20. The flow tube 16 is disposed upstream of the forward end 20 and is operably connected to a source of pressurized water (not shown), such that a stream of water can be conducted from the source of pressurized water to the open forward end 20 of the housing 14 via the flow tube 16. In the embodiment illustrated in FIG. 1, the housing 14 is shown disposed within a wall 22 of a water recreational combination 12, such as a spa, hot tub or recirculation bath tub. A decorative cowling 24 is disposed on the internal side 26 of the wall 22 of the water recreational combination 12 for aesthetic purposes.

The strainer 18 is illustrated in FIGS. 2 and 3. The strainer 18 comprises side walls 28 having a tubular shape. The strainer 18 further comprises a downstream end 30 which is open and an upstream end 32 which has a plate 34 disposed across the upstream end 32. The plate 34 on the upstream end 32 has a plurality of apertures 36 disposed therein to allow water to flow across the plate 34. The apertures 36 typically have a diameter between about 0.03 inches and about 0.07 inches, most typically between about 0.04 inches and about 0.06 inches, so as to be capable of straining out of water flowing through the strainer 18 entrained solid matters such as sand, grit or other sediment. In the embodiment illustrated in the drawings, the side walls 28 of the strainer 18 also have a plurality of similar apertures 36 to facilitate the passage of additional water through the strainer 18. The spa jet of the invention 10 is ideal for use in a water recreational combination 12 such as that which is disclosed in co-pending U.S. patent application Ser. No. ______, filed Mar. 14, 2002, entitled ADJUSTABLE WATER THERAPY COMBINATION, the entire contents of which are incorporated herein by this reference. Such water recreational combinations 12 includes spas, hot tubs and recirculation bath tubs.

In such water recreational combinations 12, the source of pressurized water is typically water circulated from the water basin of the water recreational combination 12 via a water circulation pump.

The water jet of the invention 10 has markedly improved service life and maintenance characteristics over water jets of the prior art. Rather than suffering continual damage and/or blockage from entrained sediment, the water jet of the invention 10 strains out all such entrained sediment upstream of the sensitive water jet internal components. This markedly increases the life of the jet 10, especially where the jet 10 is a jet with a rotating water nozzle, and most especially where the rotating water nozzle is journaled on roller bearings. When and if the strainer 18 becomes clogged with sediment, the strainer 18 is quickly and easily removed from the flow tube 16 of the jet 10, whereupon it can be cleaned and/or replaced without having to remove the jet 10 from the walls 22 of the water recreational combination 12.

Having thus described the invention, it should be apparent that numerous structural modifications and adaptations may be resorted to without departing from the scope and fair meaning of the instant invention as set forth hereinabove and as described hereinbelow by the claims.

What is claimed is:

1. A water jet suitable for use in a spa, hot tub or recirculation bath tub, the water jet comprising:
(a) a housing having an open forward end;
(b) a flow tube disposed within the housing for conducting a stream of water from a source of pressurized water disposed external of the housing to the open forward end of the housing; and
(c) a strainer operatively disposed within the flow tube to filter out entrained solid material within a stream of water flowing through the flow tube.

2. The water jet of claim 1 wherein the flow tube has an inlet end and an outlet end and wherein a rotatable nozzle is rotatably attached to the outlet end of the flow tube.

3. The water jet of claim 2 wherein the rotatable nozzle is journaled by rotatable bearings.

4. The water jet of claim 1 wherein the strainer has one or more side walls, an open upstream end and a perforated downstream end.

5. The water jet of claim 4 wherein the perforated downstream end has generally circular perforations with diameters between about 0.04 inches and about about 0.06 inches.

6. The water jet of claim 1 wherein the strainer is made from a plastic material.

7. A water recreational combination comprising:
(a) a water basin capable of retaining a human being partially submerged below a quantity of water, the water basin comprising one or more side walls; and
(b) at least one water jet disposed within the one or more side walls of the water basin, the at least one water jet comprising:
(i) a housing having an open forward end;
(ii) a flow tube disposed within the housing for conducting a stream of water from a source of pressurized water disposed external of the housing to the open forward end of the housing; and
(iii) a strainer operatively disposed within the flow tube to filter out entrained solid material within a stream of water flowing through the flow tube.

8. The water recreational combination of claim 6 wherein the flow tube has an inlet end and an outlet end and wherein a rotatable nozzle is rotatably attached to the outlet end of the flow tube.

9. The water recreational combination of claim 6 wherein the rotatable nozzle is journaled by rotatable bearings.

10. The water recreational combination of claim 6 wherein the strainer has one or more side walls, an open upstream end and a perforated downstream end.

11. The water recreational combination of claim 10 wherein the perforated downstream end has generally circular perforations with diameters between about 0.04 inches and about about 0.06 inches.

12. The water recreational combination of claim 6 wherein the strainer is made from a plastic material.
